(19) United States
(12) Patent Application Publication
(10) Pub. No.: US 2024/0294356 A1
(43) Pub. Date: Sep. 5, 2024

(54) ELEVATOR AND A METHOD OF ENERGIZING AN ELEVATOR SAFETY APPARATUS

(71) Applicant: Kone Corporation, Helsinki (FI)

(72) Inventor: Lauri Stolt, Helsinki (FI)

(73) Assignee: Kone Corporation, Helsinki (FI)

(21) Appl. No.: 18/432,650

(22) Filed: Feb. 5, 2024

(30) Foreign Application Priority Data
Mar. 3, 2023 (FI) 20235254

(51) Int. Cl. B66B 1/32; B66B 1/30; B66B 3/00; B66B 5/04

(52) U.S. Cl. CPC B66B 1/32; B66B 1/30; B66B 3/002; B66B 5/04

(57) ABSTRACT

In an elevator and a method for energizing an elevator safety apparatus, the elevator includes an elevator car, adapted for transferring passengers and/or cargo between landing floors; an elevator hoisting machine for operating the elevator car; a drive unit for driving the hoisting machine; and an elevator safety apparatus including at least one of a sensor, an indicator, a control unit and an actuator for ensuring safe elevator operation. The drive unit is configured for delivering supply voltage to said elevator safety apparatus by controlling braking of the elevator hoisting machine with a braking control mode designed for energizing the safety apparatus without need for an additional backup power supply, in case of an elevator power cut.

### FIELD OF THE INVENTION

The subject matter described herein relates to elevators and in particular to solutions for supplying voltage to elevator safety devices during an elevator power cut.

### BACKGROUND

Elevator safety devices are in many cases fail-safe components. For example, elevator brakes have been designed such, that they prevent or restrain elevator car movement, when power supply of the brake device has failed. On the other hand, elevator operation may be necessary also during an elevator power cut situation, for example to move the car to the closest landing floor to rescue passengers from the car. It may also be necessary to have a control over braking torque when electricity is lost, to prevent excessive deceleration of the car. For safety reasons elevator safety system should therefore remain at least partially operational also during the power cut situation. To address these requirements elevator may be provided with a backup battery as a secondary power source, to energize at least selected elevator components during the power cut.

Backup batteries may be unreliable, and they need regular maintenance. It is also possible, that charging state of the battery is not adequate e.g. for rescue operation at the time of elevator power cut.

### SUMMARY

The objective of the present invention is to solve at least one of the above-identified problems. Therefore the invention discloses an elevator according to claim 1 and a method for energizing an elevator safety apparatus according to claim 7. Some preferred embodiments of the invention are described in the dependent claims. Some inventive embodiments, as well as inventive combinations of various embodiments, are presented in the description and in the drawings.

First aspect is an elevator comprising an elevator car adapted for transferring passengers and/or cargo between landing floors, an elevator hoisting machine for operating the elevator car and a counterweight. The elevator car and the counterweight are suspended on hoisting ropes running via a traction sheave of the elevator hoisting machine. The elevator further comprises a drive unit for driving the hoisting machine, an elevator controller, which generates control commands to move elevator car between landing floors according to service requests from elevator passengers and an elevator safety apparatus comprising at least one of a sensor, an indicator, a control unit and an actuator for ensuring safe elevator operation.

The drive unit is configured to convert regenerative braking power of the hoisting machine to a supply voltage of an elevator safety apparatus.

The drive unit is further configured to: in case of an elevator power cut, to control braking of the elevator hoisting machine with a braking control mode designed for energizing the safety apparatus from the regenerative braking power only, without using a secondary power source for energizing the safety apparatus. This can mean that there is no need for a secondary power source, such as a battery.

According to an embodiment, the braking control mode is designed for energizing the safety apparatus using only the regenerative braking power generated during the elevator power cut.

According to an embodiment, the sensor is a door zone sensor or a movement sensor indicating elevator car movement.

According to an embodiment, the indicator is a visual indicator, such as a display, or an audible indicator, such as a buzzer.

According to an embodiment, the control unit is an electronic safety controller running a safety software.

According to an embodiment, the actuator is one of a drive which controls torque of elevator hoisting machine, a brake controller, a rope gripper and an electronic overspeed governor.

According to an embodiment, the braking control mode is designed for reducing speed of an ascending elevator car to a predetermined value, in particular to the value for which the counterweight buffer is designed.

According to an embodiment, the elevator hoisting machine is supported on a fixed structure, such as in elevator shaft.

Second aspect is a method for energizing an elevator safety apparatus in an elevator comprising an elevator car and a counterweight suspended on hoisting ropes running via a traction sheave of an elevator hoisting machine. The method comprises converting, by an elevator drive unit and in case of an elevator power cut, regenerative braking power of an elevator hoisting machine to a DC supply voltage of the elevator safety apparatus, by controlling braking of an elevator hoisting machine and, consequently, braking of an elevator car in a manner enabling energizing the elevator safety apparatus from the regenerative braking power only, without using a secondary power source for energizing the safety apparatus.

According to an embodiment, controlling braking of an elevator hoisting machine and, consequently, braking of an elevator car in a manner enabling energizing the safety apparatus using only the regenerative braking power generated during the elevator power cut.

According to an embodiment obtaining, by an electronic safety controller, safety-relevant information from at least one sensor arranged to measure elevator safety status, and in case the information obtained indicates a safety problem of the elevator, issuing, by the electronic safety controller, a control signal for to bring the elevator to a safe state, the control signal causing interrupting voltage supply from the elevator drive unit to the safety actuator. Preferably, said safety actuator is an electromagnet of a hoisting machine brake.

According to an embodiment, controlling the braking of the hoisting machine to reduce speed of an ascending elevator car to a predetermined value, in particular to the value for which the counterweight buffer is dimensioned.

### BRIEF DESCRIPTION OF THE DRAWINGS

In the following, the invention will be described in more detail by the aid of some examples of its embodiments, which in themselves do not limit the scope of application of the invention, with reference to the attached drawings, wherein

FIG. 1 shows a schematic view of an elevator according to an exemplary embodiment.

FIG. 2 shows a drive unit according to an exemplary embodiment.

### MORE DETAILED DESCRIPTION OF PREFERRED EMBODIMENTS OF THE INVENTION

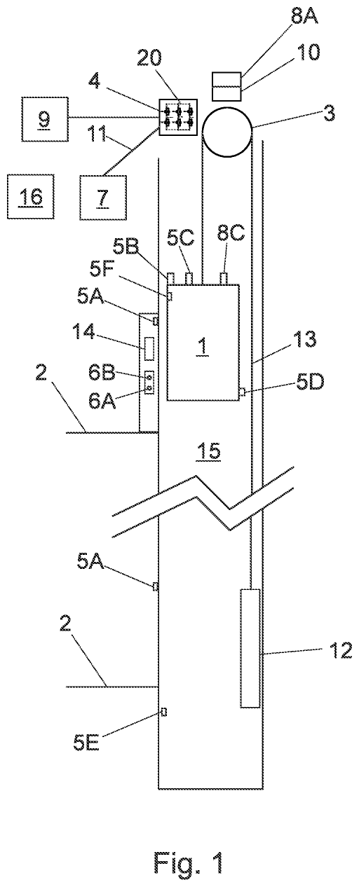

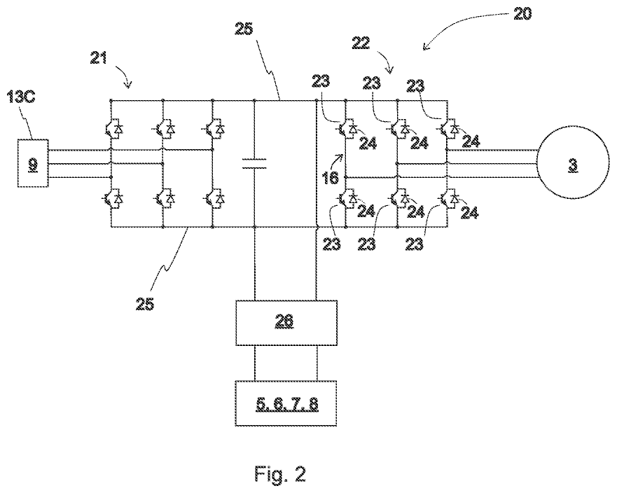

For the sake of intelligibility, in FIGS. 1 and 2 only those features are represented which are deemed necessary for understanding the invention. Therefore, for instance, certain components/functions which are widely known to be present in the art may not be represented.

FIG. 1 shows an elevator according to an exemplary embodiment. Elevator comprises an elevator car 1 and a counterweight 12 suspended on hoisting ropes 13. Hoisting ropes 13 run via a traction sheave of an elevator hoisting machine 3.

In shaft pit under elevator car 1 and counterweight 12 there may be safety buffers for the car 1 and the counterweight 12, respectively, for absorbing the impact energy of car/counterweight in case of an operational anomaly. Said safety buffers are not shown in FIG. 1.

Hoisting machine 3 has an electrical motor, preferably a synchronous AC permanent magnet motor, which provides driving torque for the elevator car 1. The elevator further comprises an elevator drive unit 4 in the form of a frequency converter.

Elevator operation is controlled by an elevator controller 16, which generates control commands to move elevator car between landing floors 2 according to service requests from elevator passengers.

The elevator comprises a safety apparatus for ensuring safe elevator operation. Hoisting machine 3 comprises brakes 10, which are controlled by electromagnets 8A, i.e. electromagnetic coils inside the brakes 10. Brakes 10 are engaged against traction sheave or rotating axis of the hoisting machine 3 to hold elevator car 1 standstill in elevator shaft 15 and opened to enable elevator car 1 movement. Opening of the brakes 10 takes place by supplying electrical current to the electromagnets 8A. Brakes 10 are engaged by interrupting the current supply.

The safety apparatus may further comprise one or more sensors, indicators, actuators and/or control units for ensuring safe elevator operation.

In normal operation, electrical power for the motor and the brakes 10, as well as for the sensors, indicators, actuators and/or control units is supplied from mains 9.

Said sensor may comprise a safety contact, such as a landing door contact 5A indicating open/closed state of a landing door, a contact 5D indicating operation of an elevator safety gear, or a car door contact 5F indicating open/closed state of an elevator car door. The sensor may also comprise a limit switch 5E indicating extreme limit for elevator car movement in an elevator shaft 15. Further, the sensor may comprise a door zone sensor 5B indicating presence of an elevator car 1 in the immediate vicinity of a landing floor 2 or a movement sensor, such as an acceleration sensor 5C or an encoder 5G indicating elevator car 1 movement.

Said indicator may be a visual indicator, such as a display 6A arranged in an elevator control panel, or an audible indicator 6B, such as a buzzer arranged e.g. into said control panel or into the elevator car 1.

Said actuator may be a brake actuator 8A, such as the electromagnet 8A of the hoisting machine brake 10 or a hydraulic actuator. The actuator may also be drive unit 4 itself. Further, the actuator may be a rope gripper contacting hoisting ropes 13 to brake movement of the car 1, or an electronic overspeed governor 8C that monitors an overspeed situation of the elevator car 1.

Said control unit may be a safety control unit 7, such as an electronic safety controller 7 running a safety software in line with safety requirements, such as in line with safety standard IEC61508 for functional safety. In particular, the electronic safety controller 7 may be designed to fulfill safety integrity level 3 (SIL 3) of said safety standard.

The elevator of FIG. 1 is operable to provide required supply voltage to the elevator safety apparatus in an elevator power cut situation and without need for a separate secondary power source, such as a separate back-up power supply-meaning no additional battery, for example, is needed for the backup power supply. Instead, the drive unit 4 is operational to deliver said supply voltage. Elevator power cut situation refers to a situation wherein electricity supply from the mains 9 has failed or has been interrupted e.g. by means of a main switch.

FIG. 2 shows in details frequency converter 20 of said drive unit 4. Frequency converter 20 comprises a rectifier 21, an inverter stage 22 and a DC link 25 between them.

Rectifier 21 may comprise power transistors as in FIG. 2, or it may implemented as a passive diode bridge, without said power transistors. Output terminals of the inverter stage 22 are connected to the windings of the motor of the hoisting machine 3. Inverter stage 22 comprises power transistors 23, such as IGBT transistors, MOSFET transistors, silicon carbide transistors or gallium nitride transistors, with antiparallel connected diodes 24, arranged as an inverter bridge. Processing unit of the drive unit (e.g. a DSP processor) generates control signals of the power transistors 23. By switching the power transistors 23 DC link voltage of the frequency converter is modulated as a variable-amplitude, variable-frequency AC voltage in the output terminals. From output terminals these AC voltage power signals are provided to the windings of the electrical motor, to control motor torque, in order to drive the hoisting machine 3.

Drive unit 4 comprises a DC/DC converter 26. DC/DC converter 26 has high-voltage input terminals, such as 650V input terminals, which are connected to DC link 25 of the frequency converter and low-voltage output terminals, such as 24 V DC terminals, which are connected to voltage supply of the safety apparatus 5, 6, 7, 8. In some embodiments the DC/DC converter 26 wakes up the system (also processing unit of the frequency converter 20) automatically, starting voltage supply when DC link voltage of the frequency converter 20 reaches a predefined limit value, such as 100V. In some alternative embodiments the processing unit of the frequency converter 20 (e.g. a DSP processor) has a very small battery or a capacitor to keep the processing unit operational also in an elevator power cut situation.

Processing unit of the frequency converter 20 has a control software with a specific braking control mode for delivering the supply voltage. When elevator car movement is detected during the power cut situation, the control program causes the frequency converter 20 to convert regenerative braking power of the hoisting machine 3, i.e. the power available from movement of the elevator car 1 to a DC supply voltage of the safety apparatus 5, 6, 7, 8, by controlling braking torque of the hoisting machine 3 and, consequently, braking of the car 1 such that the safety apparatus 5, 6, 7, 8 will be energized from the regenerative braking power only. Braking torque is controlled such that electrical power directed to the safety apparatus 5, 6, 7, 8 substantially equals to a predefined value, which corresponds to the power requirements of said safety apparatus 5, 6, 7, 8. Any regenerative power exceeding the power requirements may be consumed into heat in a suitable load, such as in the motor windings.

In some embodiments the braking control mode is for safety reasons designed for reducing speed of an ascending, i.e. upwards moving, elevator car 1 to a predetermined speed value for which the counterweight buffer is dimensioned, such that counterweight buffer is capable of absorbing kinetic energy of a counterweight moving downwards at said predetermined speed. This safety measure is especially important in situations wherein an empty elevator car is moving upwards.

Turning back to FIG. 1, sometimes in an elevator power cut situation, there is a need to move an elevator car 1 to a landing floor 2 to release passengers from the car 1. Therefore, the elevator of FIG. 1 comprises a manual brake lever 14. Brake lever 14 may be located in a machine room. In a machine-room less elevator brake lever may be located in a control cabinet disposed at a landing floor 2. By operating the brake lever 14 service technician can open the brakes 10 manually, such that elevator car will start moving as a consequence of gravity force. Service technician returns the brake lever 14 back to the braking position, when an indication has been received from an indicator device 6A, 6B that elevator car 1 has arrived at or is about to arrive to the landing floor 2. When the car 1 starts moving, rotor of the hoisting machine starts rotating. Movement of the rotor generates electromotive voltage in the motor windings. This voltage is proportional to and raises with the rotor speed. It is rectified to DC link voltage of the drive unit 4 via antiparallel-connected diodes 24 of the inverter bridge 22, and DC link voltage quickly starts raising as the car starts moving. During movement of the car 1 the drive unit 4 provides supply voltage to said indicator device 6A, 6B, by controlling braking torque of the hoisting machine 3 as disclosed above.

Sometimes it is necessary to have control over braking torque, such that excessive deceleration of an elevator car can be prevented. For example, if power cut situation occurs when elevator car 1 with full load is moving upwards, braking force of the hoisting machine brakes 10 in combination with the gravity force may cause excessive deceleration. To avoid excessive deceleration the drive unit 4 energizes the electromagnets 8A of the hoisting machine brakes 10 to keep the brakes 10 open. Again, drive unit 4 obtains supply voltage for the electromagnets 8A from regenerative braking power of the hoisting machine 3. Drive unit controls braking torque of the hoisting machine 3 such that the energy obtained corresponds to energy requirement of the electromagnets 8A.

In some exemplary embodiments drive unit 4 delivers supply voltage in a power cut situation to one or more sensors, as well as to the safety controller 7. Safety controller 7 obtains safety-relevant information from said sensors. In case the information obtained indicates a safety problem of the elevator, the safety controller 7 issues a control signal 11 (i.e. sends a new control signal or interrupts an active control signal) to bring the elevator to a safe state. This control signal 11 causes interrupting voltage supply from the drive unit 4 to the electromagnets 8A, such that the brakes 10 are engaged. Further, if the safety controller 7 detects that elevator car 1 has arrived to a door zone, it may issue the control signal 11 to stop elevator car 1 at a landing floor, to release elevator passengers from the car 1.

The invention is described above by the aid of exemplary embodiments. It is obvious to a person skilled in the art that the invention is not limited to the embodiments described above and many other applications are possible within the scope of the inventive concept defined by the claims.

1. An elevator, comprising:
an elevator car, adapted for transferring passengers and/or cargo between landing floors;
an elevator hoisting machine for operating the elevator car;
a counterweight, wherein the elevator car and the counterweight are suspended on hoisting ropes running via a traction sheave of the elevator hoisting machine;
a drive unit for driving the hoisting machine;
an elevator controller, generating control commands to move the elevator car between landing floors according to service requests from elevator passengers; and
an elevator safety apparatus comprising at least one of a sensor, an indicator, a control unit and an actuator for ensuring safe elevator operation,
wherein the drive unit is configured to convert regenerative braking power of the hoisting machine to a supply voltage of an elevator safety apparatus,
wherein the drive unit is configured to, in case of an elevator power cut, control braking of the elevator hoisting machine with a braking control mode designed for energizing the safety apparatus from the regenerative braking power only, without using a secondary power source.

2. The elevator according to claim 1, wherein the sensor is a safety contact, a limit switch, a door zone sensor or a movement sensor indicating elevator car movement.

3. The elevator according to claim 1, wherein the indicator is a visual indicator, or an audible indicator.

4. The elevator according to claim 1, wherein the control unit is an electronic safety controller running a safety software.

5. The elevator according to claim 1, wherein the actuator is one of a drive controlling torque of the elevator hoisting machine, a brake actuator, a rope gripper and an electronic overspeed governor.

6. The elevator according to claim 1, wherein the braking control mode is designed for reducing speed of an ascending elevator car to a predetermined value.

7. A method for energizing an elevator safety apparatus in an elevator comprising an elevator car and a counterweight suspended on hoisting ropes running via a traction sheave of an elevator hoisting machine, the method comprising:
converting, by an elevator drive unit, in case of an elevator power cut, regenerative braking power of an elevator hoisting machine to a DC supply voltage of an elevator safety apparatus, by controlling braking of the elevator hoisting machine and, consequently, braking of an elevator car in a manner enabling energizing the elevator safety apparatus from the regenerative braking power only, without using a secondary power source.

8. The method according to claim 7, further comprising:
obtaining, by an electronic safety controller, safety-relevant information from at least one sensor arranged to measure elevator safety status, and
in case the information obtained indicates a safety problem of the elevator, issuing, by the electronic safety controller, a control signal to bring the elevator to a safe state, the control signal causing interrupting voltage supply from the elevator drive unit to the safety actuator.

9. The method according to claim 7, further comprising:
controlling the braking of the hoisting machine to reduce speed of an ascending elevator car to a predetermined value.

10. The elevator according to claim 1, wherein the visual indicator is a display, and the audible indicator is a buzzer.

11. The elevator according to claim 1, wherein the braking control mode is designed for reducing speed of an ascending elevator car to a predetermined value for which the counterweight buffer is dimensioned.

12. The method according to claim 7, further comprising:
controlling the braking of the hoisting machine to reduce speed of an ascending elevator car to a predetermined for which the counterweight buffer is dimensioned.

13. The elevator according to claim 2, wherein the indicator is a visual indicator, or an audible indicator.

14. The elevator according to claim 2, wherein the control unit is an electronic safety controller running a safety software.

15. The elevator according to claim 3, wherein the control unit is an electronic safety controller running a safety software.

16. The elevator according to claim 2, wherein the actuator is one of a drive controlling torque of elevator hoisting machine, a brake actuator, a rope gripper and an electronic overspeed governor.

17. The elevator according to claim 3, wherein the actuator is one of a drive controlling torque of elevator hoisting machine, a brake actuator, a rope gripper and an electronic overspeed governor.

18. The elevator according to claim 4, wherein the actuator is one of a drive controlling torque of elevator hoisting machine, a brake actuator, a rope gripper and an electronic overspeed governor.

19. The elevator according to claim 2, wherein the braking control mode is designed for reducing speed of an ascending elevator car to a predetermined value for which the counterweight buffer is dimensioned.

20. The elevator according to claim 3, wherein the braking control mode is designed for reducing speed of an ascending elevator car to a predetermined value for which the counterweight buffer is dimensioned.
